(19) United States
(12) Patent Application Publication
(10) Pub. No.: US 2022/0043942 A1
(43) Pub. Date: Feb. 10, 2022

(54) CURATED NOTIFICATIONS FOR THREE-DIMENSIONAL PRINTING

(71) Applicant: Hewlett-Packard Development Company, L.P., Spring, TX (US)

(72) Inventors: Craig Peter Sayers, Palo Alto, CA (US); Carlos Rosemberg Maria de Carvalho, Palo Alto, CA (US)

(73) Assignee: Hewlett-Packard Development Company, L.P., Spring, TX (US)

(21) Appl. No.: 17/298,527

(22) PCT Filed: Apr. 26, 2019
(86) PCT No.: PCT/US2019/029301

§ 371 Date: May 28, 2021

(51) Int. Cl. G06F 30/12; G06F 30/20; B29C 64/393; B33Y 50/02

(52) U.S. Cl. CPC G06F 30/12; G06F 30/20; G06F 2113/10; B33Y 50/02; B29C 64/393

(57) ABSTRACT

A system may filter at least some notifications associated with each of a plurality of unique parts in a cohort of parts for three-dimensional printing based on a cohort-dependent recommendation value. The system calculates a cohort-dependent recommendation value for each notification based on an inverse function of the number of unique parts in the cohort with which each respective notification is associated. The system renders a printable part for display as part of a graphical user interface along with notifications applicable to the displayed printable part. The system filters the notifications by selecting and/or ordering the notifications based on their respective cohort-dependent recommendation values.

### BACKGROUND

Numerous different three-dimensional (3D) printing processes exist. The idiosyncrasies of each different 3D printing process give rise to various challenges and opportunities for designers, engineers, and other users. In some instances, many users may design, modify, print or otherwise work with the same set or cohort of parts for 3D printing.

### BRIEF DESCRIPTION OF THE DRAWINGS

The written disclosure herein describes illustrative examples that are nonlimiting and non-exhaustive. Reference is made to certain of such illustrative examples that are depicted in the figures described below.

FIG. 1 illustrates an example of a computer-based notification system.

FIG. 2 illustrates a simulated screenshot of an example of a part for three-dimensional (3D) printing along with a curated subset of notifications.

FIG. 3A illustrates another example of a simulated screenshot of a curated subset of notifications applicable to a part for 3D printing.

FIG. 3B illustrates another example of a simulated screenshot allowing a user to provide feedback on the usefulness or interest in displayed notifications.

FIG. 3C illustrates another example of a simulated screenshot allowing a user to request additional tips and/or alerts.

FIG. 3D illustrates another example of a simulated screenshot allowing a user to filter the displayed notifications.

FIG. 4 illustrates a flowchart of an example method for filtering notifications for display to a user as part of a graphical user interface prior to printing.

FIG. 5 illustrates a block diagram of components to generate customized training material based on data from a cohort of parts.

### DETAILED DESCRIPTION

Designers, engineers, and other users of three-dimensional (3D) printers, such as multi jet fusion (MJF) printers, benefit by an understanding of the unique idiosyncrasies of the printing process they are using and/or object-specific considerations. For instance, different types of 3D printing processes may have different strengths and weaknesses. Process-dependent considerations may, for example, improve design efficiency and/or print quality outcomes. A system may provide process-specific recommendations and/or other notifications to a user during the design of a part or prior to printing a part. The notifications may also serve to continually teach and train users to design parts more efficiently and with greater skill. In addition, customized or curated learning material may be provided to the user, training the user in preparation for designing and printing new parts.

A system for selecting and prioritizing 3D part recommendations may analyze parts within a cohort of parts. The cohort of parts may be defined to include a set of related parts, a set of parts used by a defined group of people, a set of parts used within a specific industry, a set of parts for a particular machine or device, or other defined set of parts. The cohort of parts may be dynamically modified to include more or fewer parts over time.

The system may analyze the parts within the cohort of parts to identify notifications applicable to each respective part. The number of notifications applicable to a given part may, in some instances, be too numerous to reasonably present to the user without overwhelming the user. Accordingly, the system may select and prioritize notifications for display as part of a graphical user interface used for printing the 3D parts. In addition, customized learning material such as manuals, may be created for a user designing parts destined for the cohort of parts. In some instances, a new part may share similar characteristics or features with one or more existing parts. The learning material may include examples of notifications which occurred in these similar parts within the cohort of parts. The learning material may, in some examples, include similar parts from the cohort as teaching examples. In addition, the customized learning material may be different for novice and expert users. For example, a novice user may be taught issues which occur most-commonly among the cohort of parts, while an expert user, having already frequently seen the commonly-occurring cases, may benefit from training on the issues which have rarely or never been seen on parts in the cohort.

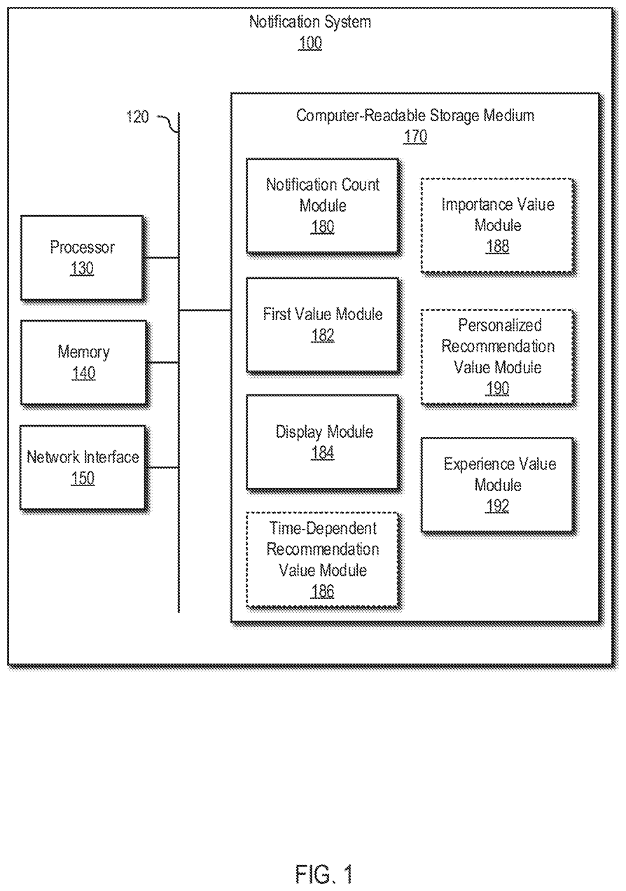

FIG. 1 illustrates an example of a notification system 100 that includes a bus 120 connecting a processor 130, memory 140, an optional network interface 150, and a computer-readable storage medium 170. The computer-readable storage medium 170 may include various modules 180-192. In the illustrated example, the modules 180-192 are implemented as instructions to be executed by the processor 130. However, in other examples one or more of the modules 180-192 may be implemented as software, firmware, hardware, or combinations thereof.

A notification count module 180 may determine a count value for each notification. The count value of a given notification is based on the number parts with which the notification is associated. A rare notification may, for example, be associated with a single part or just a few parts in the cohort of parts. A rare notification may have a relatively low count value. In contrast, a common notification may be associated with many or even all the parts in the cohort of parts. A common notification may have a relative high count value.

A first value module 182 may calculate a cohort-dependent recommendation value for each notification as an inverse function of the count value of each respective notification. Thus, relatively rare notifications with low count values are calculated to have a higher cohort-dependent recommendation value. Relatively common notifications with high count values are calculated to have lower cohort-dependent recommendation values.

A display module 184 renders a printable part to a user as part of a graphical user interface. The display module 184 may also identify notifications applicable to the printable part displayed as part of the graphical user interface. As previously noted, the number of notifications may be too great to present all of them to the user. Accordingly, the display module 184 may render at least some of the applicable notifications as part of the graphical user interface by filtering notifications as a function of their respective cohort-dependent recommendation values. The display module may order the notifications, for example, to show critical notifications first. The display module may display notifications as text or in other forms. For example, notifications may be in the form of text, drawings, 3D representations, audio, video, or the like.

In some examples, an optional time-dependent recommendation value module 186 may calculate a time-dependent recommendation value for each of the plurality of notifications. The time-dependent recommendation value may start at an initial value upon notification creation and decrease with time. Thus, the time-dependent recommendation value of each notification of each part may decrease with time. In such example, the display module 184 may render at least some of the applicable notifications as part of the graphical user interface filtered as a function of (a) their respective cohort-dependent recommendation values and (b) their respective time-dependent recommendation values.

In another example, an optional importance value module 188 may receive a user-defined importance value that is additionally used by the display module 184 to filter (e.g., select and/or order) which notifications are displayed to the user as part of the graphical user interface.

In still another example, a personalized recommendation value module 190 may associate a personalized recommendation value for each user of the system for each notification. The personalized recommendation value for a given notification may decrease from an initial value each time the notification is displayed to a given user. The display module 184 may render the applicable notifications as part of the graphical user interface filtered as a function of their respective cohort-dependent recommendation values and personalized recommendation values.

The display module 184 of the notification system 100 may render a select subset of the applicable notifications as part of the graphical user interface filtered as a function of their respective (a) cohort-dependent recommendation values, (b) importance values, and (c) personalized recommendation values.

In still another example, an experience value module 192 may associate an experience value based on their overall experience level with 3D printing and/or the user's experience using the specific printing process associated with the notification system 100, such as specific experience using MJF printers, selective laser sintering (SLS) printers, or another type of 3D print technology.

Examples of notifications that may be rendered for display to the user include warnings of potential print challenges, tips for increasing design efficiency, tips for increasing print resolution, recommendations for increasing the print speed of the part, possible errors, features that are too small to print accurately with a given printer, suggestions to improve print quality, and indications of suitability for three-dimensional printing. In some examples, different types of notifications may be displayed in color-coded format to facilitate differentiation thereof. For instance, fatal errors and serious warnings may be displayed in red, recommendations for improving the printing process (e.g., speed, resolution, quality, etc.) may be displayed in yellow, and notices that the part is well-suited for 3D printing may be displayed in green.

The notification system 100 presents a customized training experience in the form of selectively curated notifications based on one or more of the cohort-dependent recommendation values, the time-dependent recommendation values, the importance values, the personalized recommendation values, and/or the user experience values. The notifications may be process-dependent in that they relate to suggestions, warnings, and/or information arising from idiosyncrasies of the particular print process. In other examples, the notifications may alternatively or additionally be part-specific or user-specific and independent of the specific print process being utilized.

In some examples, the system may ensure that all users within a particular organization, team, company, industry, etc. are presented with the same notifications. Furthermore, the system may ensure that new notifications identified based on further or updated analysis of the parts in the cohort of parts are presented to each user associated with the cohort. Feedback on the relevancy and/or usefulness of notifications may be factored in to determine which notifications to present and/or the order in which they should be presented. Various machine-learning algorithms may be employed to adjust the importance values assigned to notifications for particular parts within the cohort of parts over time.

As previously noted, the cohort-dependent notification value can be calculated based on an inverse frequency function. In the following examples, a print recommendation, R, is used as an example of a type of notification. The cohort-dependent and frequency-dependent recommendation value, R_{CF}, can be calculated using Equation 1 below:

R_{CF}=log(N_{P}/(1+N_{R})) Equation 1

In Equation 1, N_{R} is the number of unique parts viewed in the cohort for which the recommendation is made, and N_{P} is the number of unique parts in the cohort.

A recommendation, or other notification, may be further associated with a recommendation importance value (or, more generally, a notification importance value). For example, a fatal error might be associated with a normalized importance value of 1, while insignificant informational messages might have a normalized importance value of 0.1 or even zero.

The newness of a recommendation may begin with a normalized initial value of 1 and decrease with time. A user-dependent newness of a particular recommendation for a particular part in the cohort of parts may initially be set at a normalized value of 1 and decrease each time the recommendation is displayed to the user or over time. In some examples, the user-dependent newness may decrease as a function of the number of times the specific recommendation is viewed relative to the total number of recommendations (or other notifications) the user has viewed during the same time period, as shown in Equation 2 below.

R_{CN}=log(N_{U}/(1+N_{RU})) Equation 2

In Equation 2, R_{CN} is the user-dependent newness, N_{RU} is the number of unique parts viewed by the user for which the recommendation is displayed, and N_{U} is the number of unique parts viewed by the user in the cohort. The system may combine the various values of each notification and render for display a subset of notifications having the highest total value. In some examples, a weighted function of the values may be utilized. In some examples, a recommendation or other notification may be displayed to a few people associated with a cohort of parts on a trial basis to determine the relevancy and helpfulness of the recommendation before presenting it to the larger group of users.

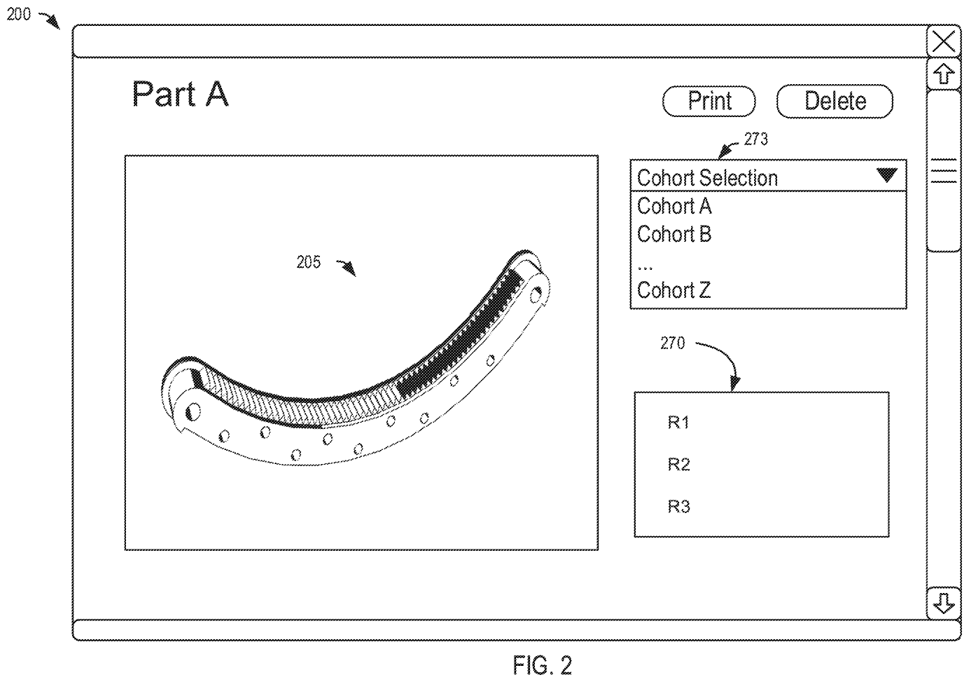

FIG. 2 illustrates a simulated screenshot of an example graphical user interface 200 with a part 205 for 3D printing along with a curated subset of notifications 270 based on a user-selected cohort. As illustrated, a user may select from a plurality of available cohorts via a cohort selection dropdown menu 273. In some examples, the system may recommend or even provide a default selection of one of the available cohorts based on an automatic analysis the user's role and/or the part 205 itself. The graphical user interface 200 may display the curated subset of notifications 270 based on any combination or function of the various values identified and described herein based on the selected cohort. The notifications 270 may aid the user in printing a part which will meet their expectations and/or teach the user how to design and print future parts.

In the illustrated example, the filtered notifications 270 may include observations and recommendations concerning the model representation of the part 205. For example, the part 205 may have an unusually large number of triangles or an invalid mesh. The subset of notifications 270 may include recommendations and observations concerning the design of the part for printing. For example, if the part had walls that were relatively thin for use with a 3D printing process, a notification 270 may include an observation that the walls are thin and/or a recommendation to make the walls thicker.

The subset of notifications 270 may additionally include observations and/or recommendations concerning how to print the part with a particular print process. For example, with some print processes there may be a higher resolution in some axes, and so there may be an advantage in changing the orientation of the part when printing to take best advantage of the higher resolution.

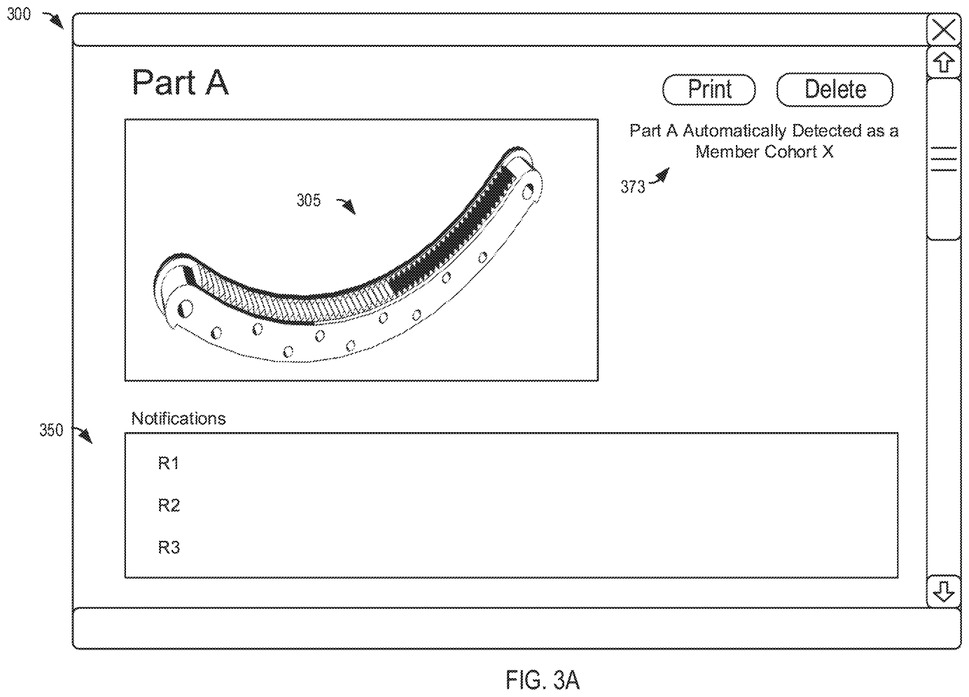

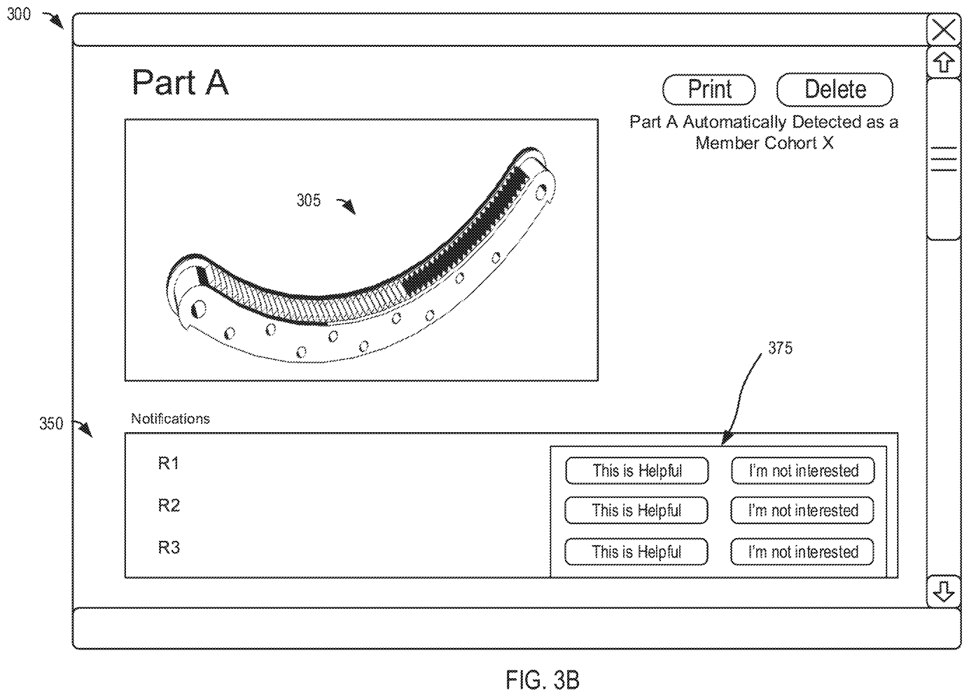

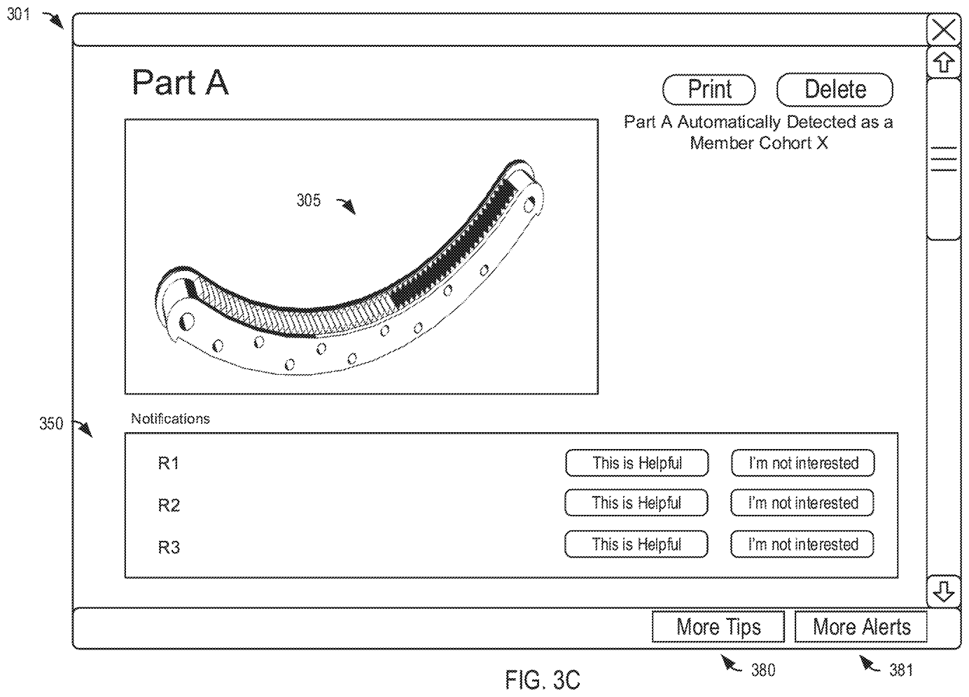

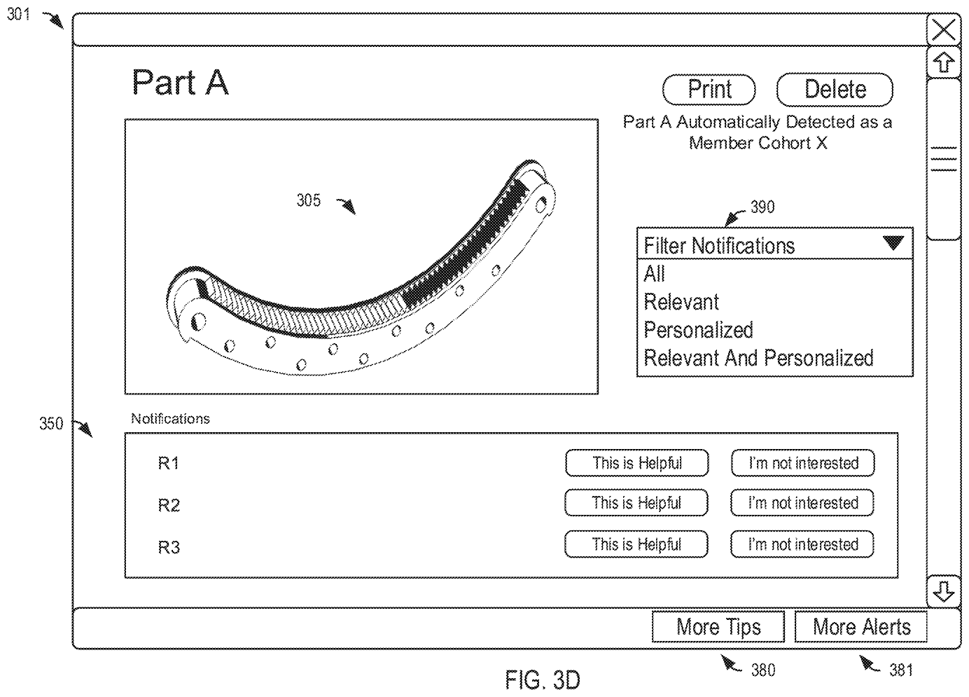

FIG. 3A illustrates another example of a simulated screenshot of a graphical user interface 300 of a curated subset of notifications 350 applicable to a part 305 for 3D printing. In the illustrated example, the part 305 is displayed smaller to allow for more notifications and/or more detailed descriptions of each notification. Additionally, in the illustrated example the cohort is automatically detected and selected. For instance, the system may select “Cohort X” for Part A 305 based on an analysis of the part itself, subcomponents of the part, the user's role, the company, department, or group with which the user is associated, or other criteria.

FIG. 3B illustrates another example of a simulated screenshot of a graphical user interface 301 allowing a user to provide feedback on the usefulness or interest in displayed notifications 350 via feedback icons 375. If a user initially indicates a notification is useful, the notification may be repeatedly displayed to the user based on relatively high personal relevance values. The system may later identify that the user is ignoring the same notification and lower one or more of the personal relevance values so that it is displayed less frequently or not at all.

FIG. 3C illustrates another example of a simulated screenshot of a graphical user interface 302 allowing a user to request additional tips and/or alerts via a more tips icon 380 and a more alerts icon 381. In an example, the selection of additional tips and/or alerts relaxes the filtering of the notifications, allowing additional notifications to be shown.

FIG. 3D illustrates another example of a simulated screenshot of a graphical user interface 303 allowing a user to filter the displayed notifications 350 via a dropdown filter menu 390. The user may select to display all notifications, the most relevant notifications, the notifications filtered according to personalized value (e.g., based on user experience level and/or the time or frequency with which the user has seen the particular notification), and/or those that have a combination of high relevancy values and personalized values.

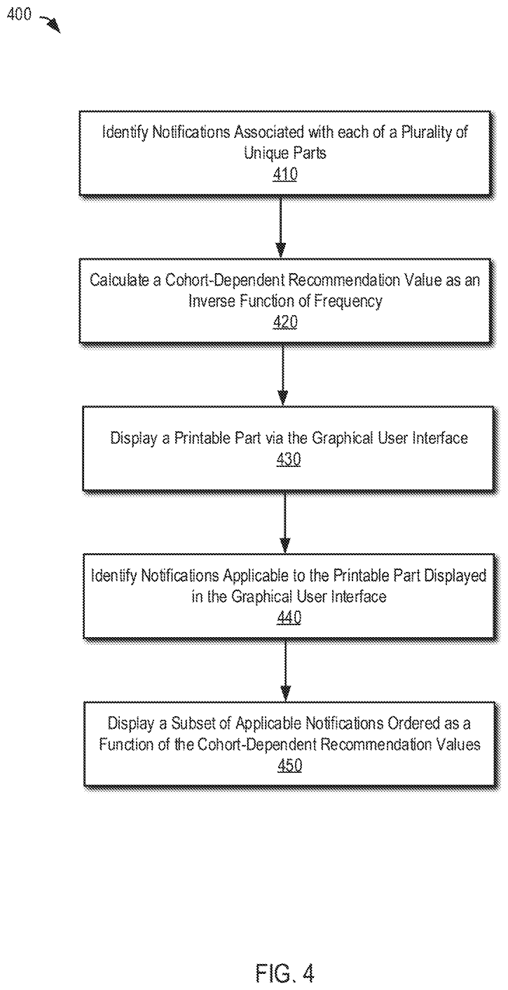

FIG. 4 illustrates a flowchart 400 of an example method for filtering (e.g., selecting and/or ordering) notifications for display to a user as part of a graphical user interface prior to printing. A system may identify, at 410, notifications associated with each of a plurality of unique parts that are part of a cohort of parts. The system may calculate, at 420, a cohort-dependent recommendation value as an inverse function of frequency. The system may render a printable part for display, at 430, via the graphical user interface. The system may identify, at 440, notifications applicable to the printable part displayed in the graphical user interface. The system may render for display, at 450, a subset of applicable notifications filtered as a function of the cohort-dependent recommendation values.

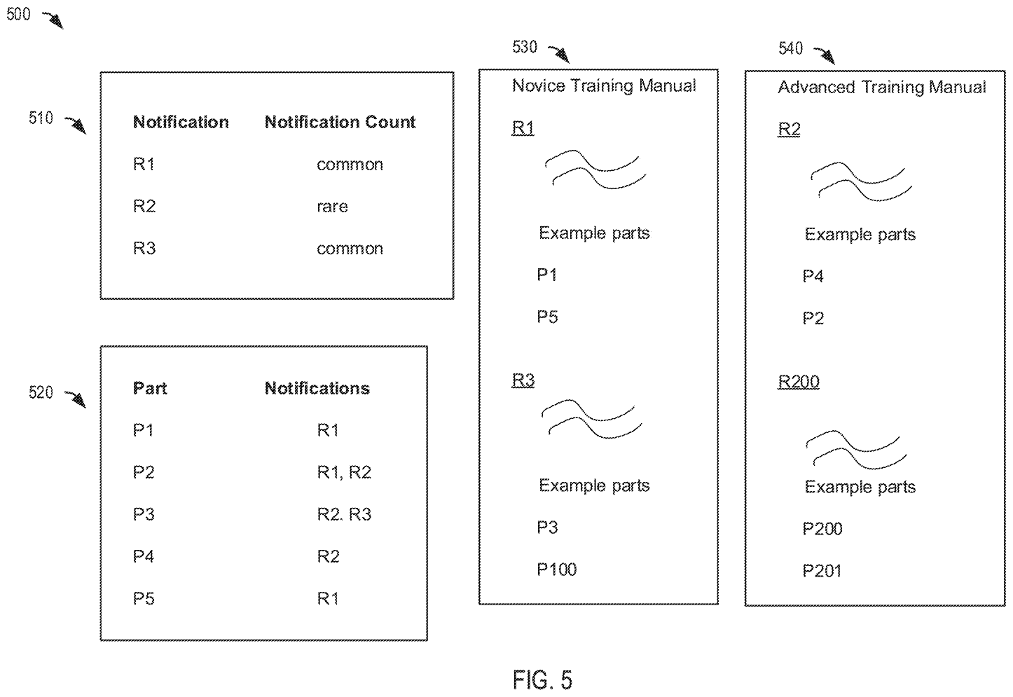

FIG. 5 illustrates a block diagram 500 of components to generate customized training material based on data from a cohort of parts, the notifications for those parts, and users of those parts. Table 510 shows each notification and the expected number of times a user of parts in the cohort will have seen it. In the illustrated example, the notification count classifies each notification R1, R2, R3 with a commonality value, e.g., common or rare. The commonality value may be calculated based on a count of the number of times a given notification would have been shown to a user who had viewed every part in the cohort. In other examples, the notification count may include a commonality value as a numerical value, such as a percentage, a calculated value, or via additional class descriptions of commonality, such as average, very rare, very common, somewhat common, etc.

Table 520 shows each part in the cohort and the notifications which may be shown for that part. The simplified example includes five parts associated with one or more of the three notifications. It is appreciated that a cohort may have tens, hundred, or thousands of parts and the number of possible notifications may be even greater. A training material module, implemented as software, firmware, and/or hardware may generate novice, advanced, and/or custom training manuals. A training manual may be a collection of organized notifications, example parts, and explanations of how each notification relates to the respective example part(s) for a cohort of parts. In other examples, the training manual may broadly include notifications, example parts, and explanations of how each notification relates to the respective example part(s) for multiple cohorts. The training manual may be presented as an integrated part of three-dimensional printing software, as a stand-alone software program, a document file (e.g., a PDF file), or even as a printed hard copy.

In the illustrated example, a novice training manual 530 includes a training material created for a novice user. The novice training manual 530 includes notifications which frequently occur, and which the novices are therefore likely to encounter. The novice training manual 530 also includes a detailed description related to each notification, and examples of parts from the cohort for which the notification might be shown.

The example parts may be selected to best illustrate the notification. For example, for notification R1, parts P1 and P5 are chosen ahead of part P2 because they only include that notification and so there may be less possibility of confusion. For notification R3, example part P3 is included because it is the only relevant part used by the cohort. Novice training manual 530 is further shown as including a part P100, which may not have been used in the cohort as an additional example to train on the notification R3.

Advanced training manual 540 shows training material for an expert user. The expert user is likely to have seen commonly-occurring notifications many times and so this advanced training can focus on notifications which occur less frequently. Advanced training manual 540 may also include detailed descriptions related to those notifications and example parts for which the notification would be shown. In addition, to further prepare the advanced user to design and print future parts, the advanced training manual 540 may include notifications, such as R200 which are not associated for any part in this cohort.

Various modules, systems, and subsystems are described herein as implementing one or more functions and/or performing one or more actions or steps. In many instances, modules, systems, and subsystems may be divided into sub-modules, subsystems, or even as sub-portions of subsystems. Modules, systems, and subsystems may be implemented in hardware, software, hardware, and/or combinations thereof.

Specific examples of the disclosure are described above and illustrated in the figures. It is, however, appreciated that many adaptations and modifications can be made to the specific configurations and components detailed above. In some cases, well-known features, structures, and/or operations are not shown or described in detail. Furthermore, the described features, structures, or operations may be combined in any suitable manner in one or more examples. It is also appreciated that the components of the examples as generally described, and as described in conjunction with the figures herein, can be arranged and designed in a wide variety of different configurations. Thus, all feasible permutations and combinations of examples are contemplated. Furthermore, it is appreciated that changes may be made to the details of the above-described examples without departing from the underlying principles thereof.

In the description above, various features are sometimes grouped together in a single example, figure, or description thereof for the purpose of streamlining the disclosure. This method of disclosure, however, is not to be interpreted as reflecting an intention that any claim now presented or presented in the future requires more features than those expressly recited in that claim. Rather, it is appreciated that inventive aspects lie in a combination of fewer than all features of any single foregoing disclosed example. The claims are hereby expressly incorporated into this Detailed Description, with each claim standing on its own as a separate example. This disclosure includes all permutations and combinations of the independent claims with their dependent claims.

What is claimed is:

1. A system, comprising:
a notification count module to determine a count value for each of a plurality of notifications associated with a cohort of parts for three-dimensional printing, wherein the count value of each notification is based on the number of unique parts within the cohort of parts with which each respective notification is associated;
a first value module to calculate a cohort-dependent recommendation value for each notification as an inverse function of the count value of each respective notification; and
a display module to:
render a printable part to a user as part of a graphical user interface, wherein the printable part is one of the unique parts in a cohort of parts,
identify notifications applicable to the printable part displayed as part of the graphical user interface, and
render at least some of the applicable notifications as part of the graphical user interface filtered as a function of their respective cohort-dependent recommendation values.

2. The system of claim 1, wherein the notifications comprise warnings of potential print challenges.

3. The system of claim 1, wherein the notifications comprise suggestions for improving print quality.

4. The system of claim 1, wherein the notifications teach the user to design and print a second part in the future with greater facility.

5. The system of claim 1, wherein each of the unique parts in the cohort of parts is associated with an importance value, and
wherein the display module is configured to render at least some of the applicable notifications as part of the graphical user interface filtered as a function of their respective cohort-dependent recommendation values and importance values.

6. The system of claim 1, further comprising:
a second value module to calculate a time-dependent recommendation value for each of the plurality of notifications that starts at an initial value upon notification creation and decreases with time, and
wherein the display module is configured to render at least some of the applicable notifications as part of the graphical user interface filtered as a function of their respective cohort-dependent recommendation values and time-dependent recommendation values.

7. The system of claim 1, further comprising:
a second value module to calculate a personalized recommendation value for each user of the system for each of the plurality of notifications that starts at an initial value the first time each respective user views each respective notification and decreases with time, and
wherein the display module is configured to render at least some of the applicable notifications as part of the graphical user interface filtered as a function of their respective cohort-dependent recommendation values and personalized recommendation values.

8. A system, comprising:
a notification identification module to identify notifications associated with each of a plurality of unique parts in a cohort of parts for three-dimensional printing,
a first value module to calculate a cohort-dependent commonality value for each of the plurality of notifications as function of a count of the number of unique parts in the cohort with which each respective notification is associated, wherein at least some of the notifications are common and at least some of the notifications are rare;
a training material module to generate:
novice training material that includes a first common notification and a first example part of the cohort of parts that typifies the first common notification; and
advanced training material that includes a first rare notification and a second example part typifying the first rare notification; and
a display module to:
render the novice training material for display to a user via an electronic display upon identification that a user is a novice user, and
render the advanced training material for display to a user via the electronic display upon identification that the user is an advanced user.

9. The system of claim 8, wherein the notifications comprise at least one of warnings of potential print challenges, suggestions for improving print quality, and indications of suitability for three-dimensional printing.

10. The system of claim 8, wherein the novice training material includes multiple common notifications and the advanced training material includes multiple rare notifications, and wherein each of the common and rare notifications in the novice and advanced training materials is associated with at least one part typifying the respective notification.

11. A method, comprising:
identifying notifications associated with each of a plurality of unique parts in a cohort of parts for three-dimensional printing;
calculating a cohort-dependent recommendation value for each of the plurality of notifications as an inverse function of a count of the number of unique parts in the cohort with which each respective notification is associated;
displaying to a user, via an electronic display, a printable part as part of a graphical user interface, wherein the printable part is one of the unique parts in a cohort of parts;
identifying notifications applicable to the printable part displayed as part of the graphical user interface; and
displaying, via the electronic display, at least some of the applicable notifications as part of the graphical user interface filtered as a function of their respective cohort-dependent recommendation values.

12. The method of claim 11, wherein each of the unique parts in the cohort of parts is associated with an importance value, and
wherein displaying at least some of the applicable notifications as part of the graphical user interface comprises displaying at least some of the applicable notifications filtered as a function of their respective cohort-dependent recommendation values and importance values.

13. The method of claim 11, further comprising:
calculating a time-dependent recommendation value for each of the plurality of notifications that starts at an initial value upon notification creation and decreases with time, and
wherein displaying at least some of the applicable notifications as part of the graphical user interface comprises displaying at least some of the applicable notifications filtered as a function of their respective cohort-dependent recommendation values and time-dependent recommendation values.

14. The method of claim 11, further comprising:
calculating a personalized recommendation value for each user of the system for each of the plurality of notifications that starts at an initial value the first time each respective user views each respective notification and decreases with time, and
wherein displaying at least some of the applicable notifications as part of the graphical user interface comprises displaying at least some of the applicable notifications filtered as a function of their respective cohort-dependent recommendation values and personalized recommendation values.

15. The method of claim 11, wherein the user is associated with an experience level,
wherein each of the unique parts in the cohort of parts is associated with an operator-assigned experience value, and
wherein displaying at least some of the applicable notifications as part of the graphical user interface comprises displaying at least some of the applicable notifications filtered as a function of their respective cohort-dependent recommendation values, the operator-assigned experience values, and the experience level of the user.
